(19) United States
(12) Patent Application Publication
(10) Pub. No.: US 2006/0144984 A1
(43) Pub. Date: Jul. 6, 2006

(54) Sensor for activating a vehicle occupant restraint system

(75) Inventors: Markus Daeuber, Eislingen (DE); Jens Klaassen, Alfdorf (DE); Thomas Meinders, Pluederhausen (DE); Marin Christov, Dresden (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/238,541

(22) Filed: Sep. 29, 2005

(30) Foreign Application Priority Data
Sep. 29, 2004 (DE) 10 2004 047 294.7

(51) Int. Cl. B60R 22/40

(52) U.S. Cl. 242/384.2; 242/384.6

(57) ABSTRACT

A sensor for activating a vehicle occupant restraint system, in particular the locking mechanism of a safety belt retractor, has an inertia body, a bearing on which the inertia body rests, and a sensor lever arranged in an upper region of the inertia body. The sensor lever can be swiveled from a position of rest by a movement of the inertia body and thereby activates the vehicle occupant restraint system. The inertia body in a position of rest is spaced apart from the sensor lever by a gap or, in the position of rest, it contacts an abutment surface of the sensor lever in exactly one point and is spaced apart from a jacket surface of the sensor lever which adjoins the abutment surface.

### TECHNICAL FIELD

The invention relates to a sensor for activating a vehicle occupant restraint system, in particular the locking mechanism of a safety belt retractor, comprising an inertia body and a sensor lever which can be swiveled from a position of rest by a movement of the inertia body and thereby activates the vehicle occupant restraint system.

### BACKGROUND OF THE INVENTION

Such a vehicle-sensitive sensor is known for example from DE 298 22 10 and is incorporated into safety belt retractors. In the case of an impact of the vehicle, the inertia body, preferably a steel ball, moves and leads to the swiveling of the sensor lever. A coupling catch on the sensor lever is thereby guided into the coupling teeth of a blocking mechanism, which finally blocks a belt spool and prevents a withdrawal of belt webbing. The triggering of the sensor, however, also takes place at a particular oblique position of the vehicle.

In generic vehicle-sensitive sensors, the sensor lever rests on the inertia body. In order to ensure a more exact triggering of the sensor, DE 102 27 788 A discloses specially structured contact surfaces for the inertia body. The contact surfaces are generally inner sides of a lower and an upper shell of the sensor. The structure of the shell inner sides is achieved according to DE 102 27 788 A by various kinds of projections. Hereby, for example, the influence of the contamination of the sensor on the sensor triggering can be reduced. As before, the sensor triggering is of course influenced by a number of parameters. In order to be able to control the sensor more precisely, a reduction of these influential parameters such as friction or contamination would be desirable.

It is therefore an object of the present invention to reduce the number of parameters that have an influence on a sensor triggering.

### BRIEF SUMMARY OF THE INVENTION

The invention provides a sensor for activating a vehicle occupant restraint system, in particular the locking mechanism of a safety belt retractor, having an inertia body, a bearing on which the inertia body rests, and a sensor lever arranged in an upper region of the inertia body. The sensor lever can be swiveled from a position of rest by a movement of the inertia body and thereby activates the vehicle occupant restraint system. The inertia body in a position of rest is spaced apart from the sensor lever by a gap. This means, in other words, that the inertia body in the position of rest does not touch the sensor lever, and therefore no friction point exists between the inertia body and the sensor lever. The friction influence of conventional sensors, in particular the transition, which is difficult to calculate, from static friction to sliding friction, is thereby eliminated. As the inertia body in the position of rest is not in direct contact with the sensor lever, the sensor according to the invention is independent of the materials used and their material parameters and also is particularly insensitive to the influences of dirt. The influence of the surface quality and a tendency to adhesion connected therewith between the inertia body and the sensor lever likewise no longer play a part.

In one embodiment, the inertia body is spaced apart from the sensor lever and mounted such that before a triggering of the sensor, it impinges onto the sensor lever with a speed in order to swivel the latter. The sensor lever is therefore stimulated dynamically by a friction-free shock. This offers the advantage that the sensor can be controlled more exactly. The selection of materials for manufacturing the components involved (usually, inertia body of steel and sensor lever of plastic) was limited hitherto, in order to ensure a necessary mass ratio for triggering the sensor. Owing to the dynamic and friction-free triggering of the sensor according to the invention, this selection can be distinctly expanded.

In a further embodiment, the sensor is designed such that the inertia body, after a removal of the cause of the movement of the inertia body (deceleration, tilting with respect to position of rest), moves into its position of rest by itself. The locking mechanism of the belt retractor is therefore automatically released again and the vehicle occupant restraint system can be activated again at any time by the sensor.

The inertia body can be a ball, with the advantage that these balls can be produced particularly simply and have already been tried and tested as inertia bodies in conventional sensors.

In another embodiment, the inertia body is mounted so as to be tiltable, whereby a desired precise triggering of the sensor is able to be achieved very readily. Simple geometric changes, such as for example a foot width of the inertia body, the vertical position of its centre of gravity, or the inclination of a side wall of the bearing, decisively influence the tilting or the movement into the position of rest. In the sensor geometry, it is merely important that the function principle of the “standing man”, i.e. the independent righting of the inertia body into its position of rest, is maintained. Alternatively, the inertia body can also be mounted suspended.

Preferably, the inertia body has a centre of gravity which lies above its centre in the vertical direction. This top-heavy type of construction increases the sensitivity of the sensor and the impulse which is transferred to the sensor lever.

In the sensor according to the invention, an upper shell can be provided as part of the sensor lever and surrounds the upper region of the inertia body. The bearing on which the sensor lever rests can be constructed as a lower shell. These sensor elements have proved to be successful in connection with a ball as inertia body and offer additional advantages in the configuration of the sensor according to the invention.

In a particular embodiment, in the position of rest of the inertia body the gap thickness amounts to between 0.15 mm and 0.6 mm. In this way, the inertia body can receive sufficient kinetic energy before the shock, in order to dynamically activate the locking mechanism of the safety belt retractor.

In a further sensor in accordance with the invention for activating a vehicle occupant restraint system, in particular a locking mechanism of a safety belt retractor, the sensor comprises an inertia body and a bearing on which said inertia body rests. The sensor lever is arranged in an upper region of the inertia body, can be swiveled from a position of rest by a movement of the inertia body and thereby activates said vehicle occupant restraint system. The sensor lever has an abutment surface and a jacket surface adjoining the abutment surface, the inertia body in its position of rest touching the abutment surface in one point and being spaced apart from the jacket surface. After a movement, the inertia body strikes against the jacket surface in order to deflect the sensor lever. As compared with the prior art with a line contact or a plurality of spaced apart point contacts between the sensor lever and the inertia body, in this embodiment the friction is distinctly reduced owing to only one contact point.

In this embodiment, the abutment surface of the sensor lever in its position of rest is preferably oriented substantially horizontally and is preferably flat. This offers the advantage that upon a movement of the inertia body, the difference between the potential energy of the sensor lever and the potential energy of the inertia body initially remains substantially constant. Due to this shape of the sensor lever, the inertia body initially performs no lifting work, but can pick up speed up to the impact onto the jacket surface. In this way, all the advantages of a dynamic sensor triggering are given in this embodiment as well.

### BRIEF DESCRIPTION OF THE DRAWINGS

FIG. 1 shows a view of a belt retractor, partially in section, with a sensor according to the invention, in a first embodiment,

FIG. 2 shows a diagrammatic detail section through the inertia body and the sensor lever of the first embodiment,

FIG. 3 shows a section through a second embodiment of the sensor according to the invention, and

FIG. 4 shows a diagrammatic section through part of the sensor lever and the inertia body in a third embodiment of the sensor according to the invention.

### DETAILED DESCRIPTION OF THE PREFERRED EMBODIMENTS

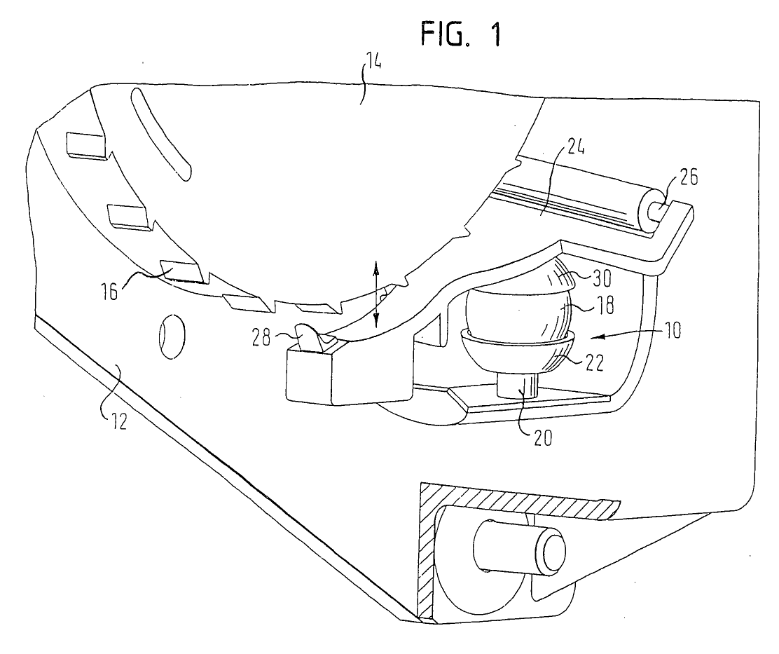

In FIG. 1 a sensor 10 is illustrated for the vehicle-sensitive triggering of the locking mechanism of a safety belt retractor. The housing of the safety belt retractor, in which the sensor 10 is housed, is designated by 12. The diagrammatically illustrated control disc is designated by 14, with its teeth 16. The sensor consists essentially of three parts, namely an inertia body 18 in the form of a ball, a lower sensor part, also named sensor housing 20, which has a lower shell 22 as bearing of the inertia body 18, and a sensor lever 24 arranged in an upper region 25 of the inertia body 18. The sensor lever 24 is constructed as a one-armed lever which is swivellably connected with the sensor housing 20 by means of a swivel bearing 26. At the opposite end, a control catch 28 is formed integrally with the sensor lever 24 and can engage into the teeth 16 when the sensor lever 24 swivels upwards. In addition, an upper shell 30 is formed integrally with the sensor lever 24; the upper shell 30 does not touch the inertia body 18, which, however, projects into it. The inertia body 18 is thereby secured between the lower and upper shells 22 and 30.

With an oblique position or acceleration of the vehicle, the ball in the shells 22, 30 can move out of its position of rest, in order to knock with speed against the upper shell 30 and deflect the sensor lever 24, and thereby to lead to the engagement of the control catch 28 into the control disc 14, which finally triggers the locking mechanism of the belt retractor.

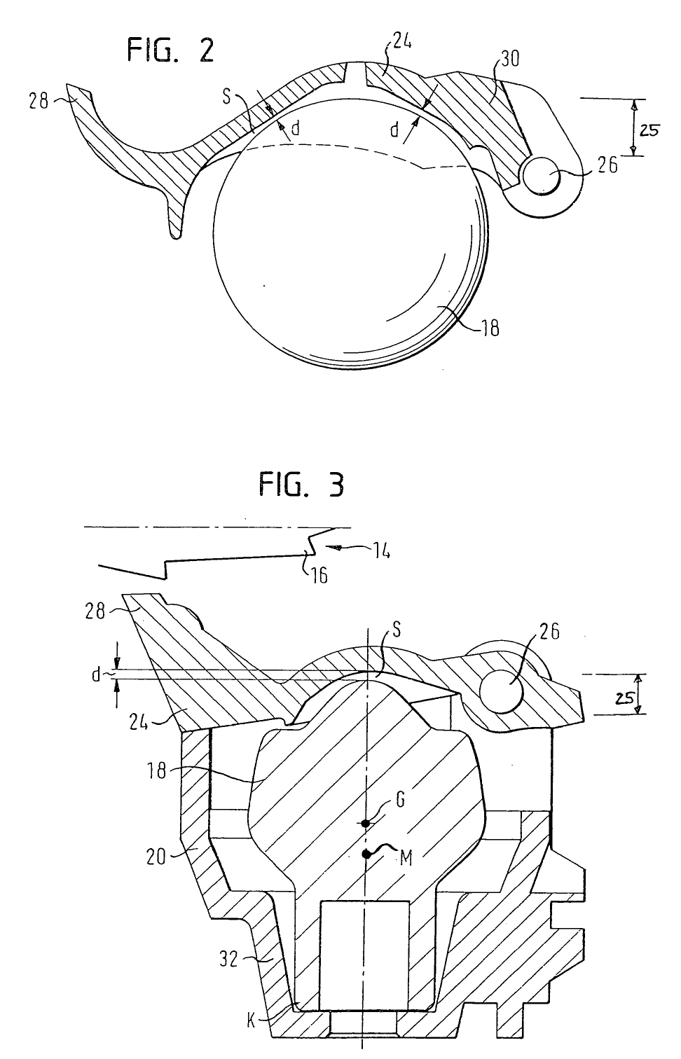

In the diagrammatic detail section of FIG. 2, it can be clearly seen that the upper shell 30 of the sensor lever 24 does not touch the inertia body 18, so that a gap S is present. The gap thickness, i.e. the minimum distance between sensor lever 24 and inertia body 18, is designated by d. A suitable stop (not shown), e.g. on the sensor housing, prevents the sensor lever 24 from swiveling downwards to a contact of the inertia body 18.

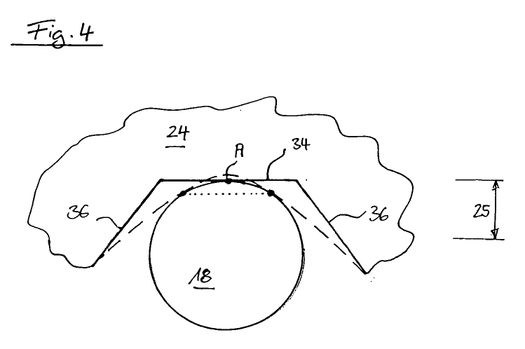

FIG. 3 shows a section through a second embodiment of the sensor according to the invention. The inertia body 18 is constructed here as a tiltably mounted top-heavy body in the “standing man” principle. Top-heavy means that its centre of gravity G lies above the body centre M in the vertical direction. The bearing of the inertia body 18 in the sensor housing 20 is constructed as a trough 32 with oblique side walls widening upwards. The gap thickness is, in turn, designated by d.

In the case of an acceleration or oblique position of the vehicle, the inertia body 18 tilts from its position of rest through an edge K at the foot of the inertia body 18, until it lies against the oblique side wall of the bearing. During the tilting process, the head of the inertia body 18 knocks against the inner side of the upper shell 30, which is formed integrally with the sensor lever 24. As a result of the impulse, the sensor lever 24 swivels from its position of rest upwards through the swivel bearing 26. Hereby, the control catch 28 engages into the teeth 16 of the control disc 14 and thereby activates the vehicle occupant restraint system. When the acceleration or oblique position of the vehicle goes again towards zero, the inertia body 18 moves into its position of rest and the sensor lever 24 moves back into its position of rest.

Some of the parameters that influence the operation of the sensor will be discussed in greater detail below.

The gap thickness d, for example, should be at least 0.15 mm in order to attain an optimum dynamic behavior. With smaller gap thicknesses d, the triggering behavior already approaches the static triggering (d=0). For larger gap thicknesses d, the dynamics of the logical function remains substantially constant.

From the point of view of acoustics, the gap thickness d should be as large as possible. In the case of stimulations in the low frequency range of up to about 15 Hz, the presence of the gap has no influence because the sensor is stimulated as a whole and causes noises of up to 55 dB. With frequencies as of about 15 Hz, a sound reduction to less than 30 dB can be attained by means of the gap. In this stimulation range, only the inertia body 18 still performs sound-generating vibrations, without, however, touching the sensor lever 24 and without swiveling it in such a way that it strikes against the teeth 16 of the control disc 14 (FIG. 1). The larger the gap, the greater this effect of sound reduction. The stimulation frequency can be hardly predicted or influenced since it depends on a multitude of factors such as the pavement quality, the type of tire, etc. Since the sensor 10, in particular for restraint systems provided at the rear seats of a vehicle, is fitted near the ears of an occupant, sound reduction is of particular importance.

For triggering the sensor 10, a certain vehicle acceleration (or vehicle deceleration) is necessary, this value being required to be within legal specifications. Since the coupling between triggering of the sensor and vehicle acceleration also depends on the gap thickness d, a maximum gap thickness of about 0.6 mm results, as research work has shown. In the sensor according to the invention, the value of vehicle acceleration as of which the sensor 10 will be triggered is decisively dependent on the gap thickness d. The vehicle inclination as of which the sensor 10 will lock or unlock, on the other hand, decisively depends on the geometry of the upper and lower shells 30, 22 of the sensor 10, which, as a whole, is especially advantageous, because owing to the functional uncoupling of the acceleration limiting value and the vehicle inclination, the desired triggering values can be set largely independently.

In summary, in the position of rest of the inertia body 18, a gap thickness d is preferably between about 0.15 mm and about 0.6 mm. For acoustic reasons, the sensors 10 are preferably produced to have gap thicknesses d of about 0.5 mm.

Tests with a view to minimizing the friction of the inertia body 18 have shown that both the adhesive sliding contacts of very smooth surfaces (with a roughness of about 1 μm) and the deformative sliding contacts of very rough surfaces (with a roughness of about 12 μm) must be minimized. In this connection, a roughness in the range of 5 to 8 μm has proved to be particularly advantageous. This roughness applies particularly to the surface of the lower shell 22 since the sensor lever 24, especially when configured in the form of the upper shell 30 of the sensor lever 24, is only in a brief shock contact with the inertia body 18.

FIG. 4 shows a detail of a third embodiment of the sensor 10. Here, the sensor lever 24 has an abutment surface 34 and a jacket surface 36 adjoining the abutment surface 34, the inertia body 18 in its position of rest contacting the abutment surface 34 in exactly one point and being spaced apart from the jacket surface 36. In practice, based on the material, wear, etc., this ideal point contact may also be a small surface area. The point contact in this embodiment, however, differs distinctly from a line contact or a contact in a plurality of non-contiguous points (or small surface areas) as are known from the prior art. The prior art is shown in dashed lines in FIG. 4. The sensor lever 24 touches the inertia body 18 along an annular line (shown dotted). By contrast, the abutment surface 34 of the sensor lever 24 of a sensor 10 according to the invention contacts the inertia body 18 only in one point A, as a result of which the friction is reduced when the inertia body 18 moves.

In the present case, in the position of rest of the sensor lever 24, the abutment surface 34 is oriented substantially horizontally and is flat. This means that upon a movement of the inertia body 18, the sensor lever 24 is not immediately raised in relation to the inertia body 18 (unlike in the prior art). That is, the inertia body 18 does not perform lifting work immediately, but picks up speed first. Finally, the inertia body 18 strikes against the jacket surface 36, thus releasing the sensor lever 24 dynamically, by a largely frictionless shock. This permits a very exact triggering of the sensor 10. In the present case, the jacket surface 36 is the jacket surface of a truncated cone and the abutment surface 34 is the flat, circular, smaller base area of the truncated cone. To produce a defined position of rest of the inertia body 18, the bearing 23 of the inertia body 18 must be configured in the shape of a shell, so that upon a movement of the inertia body 18, the latter will be lifted at once together with the sensor lever 24. In this embodiment, however, the bearing 23, that is, the lower shell 22, is designed to be so flat that this influence is marginal.

In this embodiment, both the upper shell 30 and the lower shell 22 preferably have a roughness of between 5 μm and 8 μm for minimizing the friction.

1. A sensor (10) for activating a vehicle occupant restraint system, in particular a locking mechanism of a safety belt retractor, comprising
an inertia body (18),
a bearing on which said inertia body (18) rests, and
a sensor lever (24) arranged in an upper region (25) of said inertia body (18), said sensor lever (24) being able to be swiveled from a position of rest by a movement of said inertia body (18) and thereby activates said vehicle occupant restraint system,
said inertia body (18) in a position of rest being spaced apart from said sensor lever (24) by a gap (S).

2. The sensor (10) according to claim 1, wherein said inertia body (18) is spaced apart from said sensor lever (24) and mounted such that before a triggering of said sensor (10) it impinges onto said sensor lever (24) with a speed in order to swivel it.

3. The sensor (10) according to claim 1, wherein said sensor (10) is designed such that said inertia body (18), after a removal of a cause of said movement of said inertia body (18), moves into its position of rest by itself.

4. The sensor (10) according to claim 1, wherein said inertia body (18) is a ball.

5. The sensor (10) according to claim 1, wherein said inertia body (18) is mounted so as to be tiltable.

6. The sensor (10) according to claim 1, wherein said inertia body (18) has a centre of gravity (G) which lies above its centre (M) in a vertical direction.

7. The sensor (10) according to claim 1, wherein an upper shell (30) is provided as part of said sensor lever (24).

8. The sensor (10) according to claim 7, wherein said upper shell (30) surrounds said upper region (25) of said inertia body (18).

9. The sensor (10) according to claim 7, wherein said upper shell (30) has a roughness in a range of 5 to 8 μm.

10. The sensor (10) according to claim 1, wherein said bearing on which said sensor lever (24) rests is constructed as a lower shell (22).

11. The sensor (10) according to claim 10, wherein said lower shell (22) has a roughness in a range of 5 to 8 μm.

12. The sensor (10) according to claim 1, wherein in said position of rest of said inertia body (18), a thickness (d) of said gap (S) amounts to between 0.15 mm and 0.6 mm.

13. A sensor (10) for activating a vehicle occupant restraint system, in particular a locking mechanism of a safety belt retractor, comprising
an inertia body (18),
a bearing on which said inertia body (18) rests, and
a sensor lever (24) arranged in an upper region (25) of said inertia body (18), said sensor lever (24) being able to be swiveled from a position of rest by a movement of said inertia body (18) and thereby activates said vehicle occupant restraint system,
said sensor lever (24) having an abutment surface (34) and a jacket surface (36) adjoining said abutment surface (34), said inertia body (18) in its position of rest contacting said abutment surface (34) in one point and being spaced apart from said jacket surface (36), and said inertia body 18, after a movement, striking against said jacket surface (36) in order to deflect said sensor lever (24).

14. The sensor (10) according to claim 13, wherein said abutment surface (34) of said sensor lever (24) in its position of rest is oriented substantially horizontally and is flat.

15. The sensor (10) according to claim 13, wherein said sensor (10) is designed such that said inertia body (18), after a removal of a cause of said movement of said inertia body (18), moves into its position of rest by itself.

16. The sensor (10) according to claim 13, wherein said inertia body (18) is a ball.

17. The sensor (10) according to claim 13, wherein said inertia body (18) is mounted so as to be tiltable.

18. The sensor (10) according to claim 13, wherein said inertia body (18) has a centre of gravity (G) which lies above its centre (M) in a vertical direction.

19. The sensor (10) according to claim 13, wherein an upper shell (30) is provided as part of said sensor lever (24).

20. The sensor (10) according to claim 19, wherein said upper shell (30) surrounds said upper region (25) of said inertia body (18).

21. The sensor (10) according to claim 19, wherein said upper shell (30) has a roughness in a range of 5 to 8 μm.

22. The sensor (10) according to claim 13, wherein said bearing on which said sensor lever (24) rests is constructed as a lower shell (22).

23. The sensor (10) according to claim 22, wherein said lower shell (22) has a roughness in a range of 5 to 8 μm.
